(19) United States
(12) Patent Application Publication
(10) Pub. No.: US 2014/0002730 A1
(43) Pub. Date: Jan. 2, 2014

(54) ADAPTIVE FRAME RATE CONTROL

(71) Applicant: QUALCOMM Incorporated, San Diego, CA (US)

(72) Inventors: Steven S. Thomson, San Diego, CA (US); Mriganka Mondal, San Diego, CA (US); Nishant Hariharan, San Diego, CA (US); Edoardo Regini, San Diego, CA (US)

(21) Appl. No.: 13/929,614

(22) Filed: Jun. 27, 2013

Related U.S. Application Data
(60) Provisional application No. 61/665,583, filed on Jun. 28, 2012.

(51) Int. Cl. H04N 7/01

(52) U.S. Cl. CPC H04N 7/0127
USPC 348/441

(57) ABSTRACT

The present disclosure provides for systems, methods, and apparatus for image processing. These systems, methods, and apparatus may compare a current frame to at least one previous frame to determine an amount of difference. The amount of difference between the current frame and the at least one previous frame may be compared to a threshold value. Additionally, the frame rate may be adjusted based on the comparison of the amount of difference between the current frame and the at least one previous frame and the threshold value. Another example may determine an amount of perceivable difference between a current frame and at least one previous frame and adjust a frame rate based on the determined amount of perceivable difference between the current frame and the at least one previous frame.

This application claims the benefit of U.S. Provisional Application No. 61/665,583, filed Jun. 28, 2012, the entire content of which is incorporated herein by reference.

### TECHNICAL FIELD

This disclosure relates to image processing and more particularly, some examples relate to techniques for controlling the rate at which images are displayed.

### BACKGROUND

Various components such as graphics processing units (GPUs), video codecs, and camera processors compose an image and store the image in memory. A display processor may retrieve the stored image from memory. In some examples, the display processor may perform various types of processing on the stored images, and output the processed image to the display such that the image may be viewed on the display. In some examples, the image may be one of a series of images, pictures, or frames in a video.

### SUMMARY

The techniques described in this disclosure are directed to techniques applicable to an adaptive frame rate display control system. For instance, the techniques described in this disclosure may be implemented in a system to achieve a reduction in the generation of unnecessary frames. For example, an approximate measure of the perceptibility of changes between successive frames may be determined and the frame rate may be adjusted based on the determination.

In one example, the disclosure presents image processing that include determining an amount of perceivable difference between a current frame and at least one previous frame and adjusting a frame rate based on the determined amount of perceivable difference between the current frame and the at least one previous frame.

In another example, the disclosure describes a method for image processing that includes comparing a current frame to at least one previous frame to determine an amount of difference, comparing the amount of difference between the current frame and the at least one previous frame to a threshold value, and adjusting a frame rate based on the comparison of the amount of difference between the current frame and the at least one previous frame and the threshold value.

In another example, the disclosure describes a device for image processing that includes a processor configured to compare a current frame to at least one previous frame to determine an amount of difference, compare the amount of difference between the current frame and the at least one previous frame to a threshold value, and adjust a frame rate based on the comparison of the amount of difference between the current frame and the at least one previous frame and the threshold value.

In another example, the disclosure describes a device for image processing that includes means for comparing a current frame to at least one previous frame to determine an amount of difference, means for comparing the amount of difference between the current frame and the at least one previous frame to a threshold value, and means for adjusting a frame rate based on the comparison of the amount of difference between the current frame and the at least one previous frame and the threshold value.

In another example, the disclosure describes a computer-readable storage medium. The computer-readable storage medium having stored thereon instructions that upon execution cause one or more processors to compare a current frame to at least one previous frame to determine an amount of difference, compare the amount of difference between the current frame and the at least one previous frame to a threshold value, and adjust a frame rate based on the comparison of the amount of difference between the current frame and the at least one previous frame and the threshold value.

In some examples, the disclosure describes various methods. A wide variety of processors, processing units, and apparatuses may be configured to implement the example methods. The disclosure also describes computer-readable storage media that may be configured to perform the functions of any one or more of the example methods.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example computing device that may be used to implement the techniques described in this disclosure.

FIG. 2 is a block diagram illustrating an example display interface that may implement one or more example techniques described in this disclosure.

FIG. 3 is a block diagram illustrating an example of the frame rate controller of FIG. 2 in greater detail.

FIG. 4 is a block diagram illustrating another example of the frame rate controller of FIG. 2 in greater detail.

FIG. 5 is a block diagram illustrating another example of the frame rate controller of FIG. 2 in greater detail.

FIG. 6 is a flowchart illustrating an example method in accordance with one or more examples described in this disclosure.

FIG. 7 is a flowchart illustrating an example method in accordance with one or more examples described in this disclosure.

### DETAILED DESCRIPTION

Generally, frames output to a display may be generated in a manner that is not correlated to changes that are noticeable. Accordingly, multiple frames may be generated even though there is no perceptible change between the frames. The generation of the unnecessary frames may result in one or more of the following: extra power consumption, use of extra processor cycles on a central processing unit (CPU), use of extra processor cycles on a graphics processing unit (GPU), use of extra processor cycles on another processing unit, and extra bus usage. For example, some displays may use more power when display values are written to the display. Accordingly, unnecessarily writing display values to the display may increase power consumption unnecessarily.

This disclosure describes a number of examples of techniques and systems for adaptive frame rate adjustment in an image processing system. Some examples may compare a current frame to at least one previous frame to determine an amount of difference. Such an example may compare the amount of difference between the current frame and the at least one previous frame to a threshold value. The frame rate may then be adjusted based on the comparison of the amount of difference between the current frame and the at least one previous frame and the threshold value.

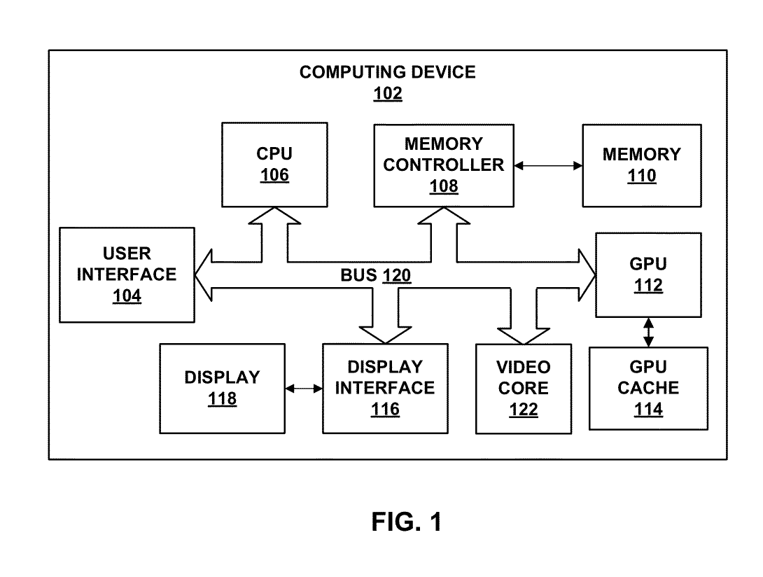

FIG. 1 is a block diagram illustrating an example computing device 102 that may be used to implement the techniques described in this disclosure. Computing device 102 may comprise a personal computer, a desktop computer, a laptop computer, a computer workstation, a video game platform or console, a wireless communication device (such as, e.g., a mobile telephone, a cellular telephone, a satellite telephone, and/or a mobile telephone handset), a landline telephone, an Internet telephone, a handheld device such as a portable video game device or a personal digital assistant (PDA), a personal music player, a video player, a display device, a television, a television set-top box, a server, an intermediate network device, a mainframe computer or any other type of device that processes and/or displays graphical data.

As illustrated in the example of FIG. 1, computing device 102 includes a user interface 104, a CPU 106, a memory controller 108, a system memory 110, GPU 112, a GPU cache 114, a display interface 116, a display 118, bus 120, and video core 122. As illustrated in FIG. 1, video core 122 may be a separate functional block. In other examples, video core 122 may be part of GPU 112, display interface 116, or some other functional block illustrated in FIG. 1. User interface 104, CPU 106, memory controller 108, GPU 112 and display interface 116 may communicate with each other using bus 120. It should be noted that the specific configuration of buses and communication interfaces between the different components illustrated in FIG. 1 is merely exemplary, and other configurations of computing devices and/or other graphics processing systems with the same or different components may be used to implement the techniques of this disclosure.

CPU 106 may comprise a general-purpose or a special-purpose processor that controls operation of computing device 102. A user may provide input to computing device 102 to cause CPU 106 to execute one or more software applications. The software applications that execute on CPU 106 may include, for example, an operating system, a word processor application, an email application, a spreadsheet application, a media player application, a video game application, a graphical user interface application or another program. The user may provide input to computing device 102 via one or more input devices (not shown) such as a keyboard, a mouse, a microphone, a touch pad or another input device that is coupled to computing device 102 via user interface 104.

The software applications that execute on CPU 106 may include one or more graphics rendering instructions that instruct GPU 112 to cause the rendering of graphics data to display 118. In some examples, the software instructions may conform to a graphics application programming interface (API), such as, e.g., an Open Graphics Library (OpenGL®) API, an Open Graphics Library Embedded Systems (OpenGL ES) API, a Direct3D API, a DirectX API, a RenderMan API, a WebGL API, or any other public or proprietary standard graphics API. In order to process the graphics rendering instructions, CPU 106 may issue one or more graphics rendering commands to GPU 112 to cause GPU 112 to perform some or all of the rendering of the graphics data. In some examples, the graphics data to be rendered may include a list of graphics primitives, e.g., points, lines, triangles, quadralaterals, triangle strips, patches, etc.

Memory controller 108 facilitates the transfer of data going into and out of system memory 110. For example, memory controller 108 may receive memory read requests and memory write requests from CPU 106 and/or GPU 112, and service such requests with respect to system memory 110 in order to provide memory services for the components in computing device 102. Memory controller 108 is communicatively coupled to system memory 110. Although memory controller 108 is illustrated in the example computing device 102 of FIG. 1 as being a processing module that is separate from both CPU 106 and system memory 110, in other examples, some or all of the functionality of memory controller 108 may be implemented on one or more of CPU 106, GPU 112, and system memory 110.

System memory 110 may store program modules and/or instructions that are accessible for execution by CPU 106 and/or data for use by the programs executing on CPU 106. For example, system memory 110 may store user applications and graphics data associated with the applications. System memory 110 may also store information for use by and/or generated by other components of computing device 102. For example, system memory 110 may act as a device memory for GPU 112 and may store data to be operated on by GPU 112 as well as data resulting from operations performed by GPU 112. For example, system memory 110 may store any combination of path data, path segment data, surfaces, texture buffers, depth buffers, cell buffers, vertex buffers, frame buffers, or the like. In addition, system memory 110 may store command streams for processing by GPU 112. System memory 110 may include one or more volatile or non-volatile memories or storage devices, such as, for example, random access memory (RAM), static RAM (SRAM), dynamic RAM (DRAM), synchronous dynamic random access memory (SDRAM), read-only memory (ROM), erasable programmable ROM (EPROM), electrically erasable programmable ROM (EEPROM), Flash memory, a magnetic data media or an optical storage media.

GPU 112 may be configured to execute commands that are issued to GPU 112 by CPU 106. The commands executed by GPU 112 may include graphics commands, draw call commands, GPU state programming commands, memory transfer commands, general-purpose computing commands, kernel execution commands, etc. The memory transfer commands may include, e.g., memory copy commands, memory compositing commands, and block transfer (blitting) commands.

In some examples, GPU 112 may be configured to perform graphics operations to render one or more graphics primitives to display 118. In such examples, when one of the software applications executing on CPU 106 requires graphics processing, CPU 106 may provide graphics data to GPU 112 for rendering to display 118 and issue one or more graphics commands to GPU 112. The graphics commands may include, e.g., draw call commands, GPU state programming commands, memory transfer commands, blitting commands, etc. The graphics data may include vertex buffers, texture data, surface data, etc. In some examples, CPU 106 may provide the commands and graphics data to GPU 112 by writing the commands and graphics data to system memory 110, which may be accessed by GPU 112.

In further examples, GPU 112 may be configured to perform general-purpose computing for applications executing on CPU 106. In such examples, when one of the software applications executing on CPU 106 decides to off-load a computational task to GPU 112, CPU 106 may provide general-purpose computing data to GPU 112, and issue one or more general-purpose computing commands to GPU 112. The general-purpose computing commands may include, e.g., kernel execution commands, memory transfer commands, etc. In some examples, CPU 106 may provide the commands and general-purpose computing data to GPU 112 by writing the commands and graphics data to system memory 110, which may be accessed by GPU 112.

GPU 112 may, in some instances, be built with a highly-parallel structure that provides more efficient processing than CPU 106. For example, GPU 112 may include a plurality of processing elements that are configured to operate on multiple vertices, control points, pixels and/or other data in a parallel manner. The highly parallel nature of GPU 112 may, in some instances, allow GPU 112 to render graphics images (e.g., GUIs and two-dimensional (2D) and/or three-dimensional (3D) graphics scenes) onto display 218 more quickly than rendering the images using CPU 106. In addition, the highly parallel nature of GPU 112 may allow GPU 112 to process certain types of vector and matrix operations for general-purposed computing applications more quickly than CPU 106.

GPU 112 may, in some examples, be integrated into a motherboard of computing device 102. In other instances, GPU 112 may be present on a graphics card that is installed in a port in the motherboard of computing device 102 or may be otherwise incorporated within a peripheral device configured to interoperate with computing device 102. In further instances, GPU 112 may be located on the same microchip as CPU 106 forming a system on a chip (SoC). GPU 112 may include one or more processors, such as one or more microprocessors, application specific integrated circuits (ASICs), field programmable gate arrays (FPGAs), digital signal processors (DSPs), or other equivalent integrated or discrete logic circuitry.

In some examples, GPU 112 may be directly coupled to GPU cache 114. Thus, GPU 112 may read data from and write data to GPU cache 114 without necessarily using bus 120. In other words, GPU 112 may process data locally using a local storage, instead of off-chip memory. This allows GPU 112 to operate in a more efficient manner by eliminating the need of GPU 112 to read and write data via bus 120, which may experience heavy bus traffic. In some instances, however, GPU 112 may not include a separate cache, but instead utilize system memory 110 via bus 120. GPU cache 114 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), Flash memory, a magnetic data media, or an optical storage media.

CPU 106, GPU 112, or both may store rendered image data in a frame buffer that is allocated within system memory 110. Display interface 116 may retrieve the data from the frame buffer and configure display 118 to display the image represented by the rendered image data. In some examples, display interface 116 may include a digital-to-analog converter (DAC) that is configured to convert the digital values retrieved from the frame buffer into an analog signal consumable by display 118. In other examples, display interface 116 may pass the digital values directly to display 118 for processing.

Display 118 may include a monitor, a television, a projection device, a liquid crystal display (LCD), a plasma display panel, a light emitting diode (LED) array, a cathode ray tube (CRT) display, electronic paper, a surface-conduction electron-emitted display (SED), a laser television display, a nanocrystal display or another type of display unit. Display 118 may be integrated within computing device 102. For instance, display 118 may be a screen of a mobile telephone handset or a tablet computer. Alternatively, display 118 may be a stand-alone device coupled to computing device 102 via a wired or wireless communications link. For instance, display 118 may be a computer monitor or flat panel display connected to a personal computer via a cable or wireless link.

Bus 120 may be implemented using any combination of bus structures and bus protocols including first, second and third generation bus structures and protocols, shared bus structures and protocols, point-to-point bus structures and protocols, unidirectional bus structures and protocols, and bidirectional bus structures and protocols. Examples of different bus structures and protocols that may be used to implement bus 120 include, e.g., a HyperTransport bus, an InfiniBand bus, an Advanced Graphics Port bus, a Peripheral Component Interconnect (PCI) bus, a PCI Express bus, an Advanced Microcontroller Bus Architecture (AMBA) Advanced High-performance Bus (AHB), an AMBA Advanced Peripheral Bus (APB), and an AMBA Advanced eXentisible Interface (AXI) bus. Other types of bus structures and protocols may also be used.

As will be described in more detail below, computing device 102 may be used for image processing in accordance with the systems and methods described herein. For example, a processor, such as CPU 106, GPU 112, or other processor, e.g., as part of display interface 116, may be configured to compare a current frame to at least one previous frame to determine an amount of difference. The processor may also compare the amount of difference between the current frame and the at least one previous frame to a threshold value. The processor may also adjust a frame rate based on the comparison of the amount of difference between the current frame and the at least one previous frame and the threshold value.

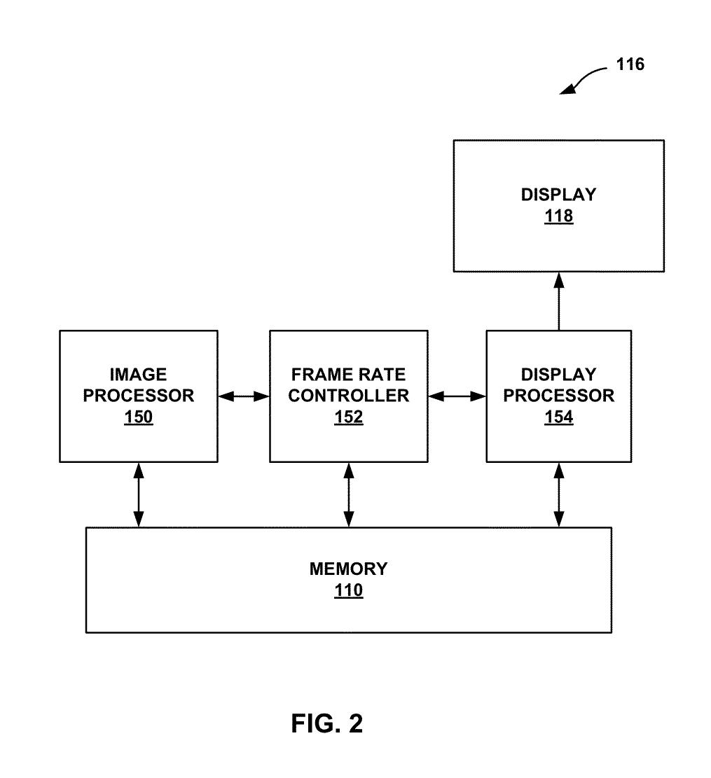

FIG. 2 is a block diagram illustrating an example of an apparatus that may implement one or more example techniques described in this disclosure. FIG. 2 illustrates display interface 116 that includes image processor 150, display processor 154, system memory 110, display 118, and frame rate controller 152. Display interface 116 may include components in addition to those illustrated in FIG. 2 such as a CPU, one or more user interfaces for interacting with display interface 116, a transceiver module for wireless or wired transmission and reception of data, and the like. Examples of display interface 116 include, but are not limited to, video devices, media players, set-top boxes, wireless handsets such as mobile telephones and so-called smartphones, personal digital assistants (PDAs), desktop computers, laptop computers, gaming consoles, video conferencing units, tablet computing devices, and the like.

Examples of image processor 150, display processor 154, and frame rate controller 152 may include, but are not limited to, a digital signal processor (DSP), a general purpose microprocessor, application specific integrated circuit (ASIC), field programmable logic array (FPGA), or other equivalent integrated or discrete logic circuitry. In some examples, image processor 150, display processor 154, and/or frame rate controller 152 may be microprocessors designed for specific usage. Furthermore, although image processor 150, display processor 154, and frame rate controller 152 are illustrated as separate components, aspects of this disclosure are not so limited. For example, image processor 150, display processor 154, and frame rate controller 152 may reside in a common integrated circuit (IC).

Image processor 150 may be any example of a processing unit that is configured to output an image. Examples of image processor 150 include, but are not limited to, a video codec that generates video images, a GPU that generates graphic images, and a camera processor that generates picture images captured by a camera. In general, image processor 150 may be any processing unit that generates or composes visual content that is to be displayed and/or rendered on display 118. Image processor 150 may output a generated image to system memory 110.

System memory 110 is the system memory of display interface 116 and resides external to image processor 150, display processor 154, and frame rate controller 152. In the example of FIG. 2, system memory 110 may store the image outputted by image processor 150 or frame rate controller 152. Display processor 154 or frame rate controller 152 may retrieve the image from system memory 110 and perform processing on the image such that the displayed and/or rendered image on display 118 is substantially similar to the original image.

Examples of system memory 110 include, but are not limited to, a random access memory (RAM), such as static random access memory (SRAM) or dynamic random access memory (DRAM), a read only memory (ROM), FLASH memory, or an electrically erasable programmable read-only memory (EEPROM), or any other medium that can be used to carry or store desired program code in the form of instructions or data structures and that can be accessed by a computer or a processor. System memory 110 may, in some examples, be considered as a non-transitory storage medium. The term “non-transitory” may indicate that the storage medium is not embodied in a carrier wave or a propagated signal. However, the term “non-transitory” should not be interpreted to mean that system memory 110 is non-movable. As one example, system memory 110 may be removed from display interface 116, and moved to another apparatus. As another example, a storage device, substantially similar to system memory 110, may be inserted into display interface 116. In certain examples, a non-transitory storage medium may store data that can, over time, change (e.g., in RAM).

Display processor 154 may be configured to implement various processing on the image retrieved from system memory 110. For example, display processor 154 may perform picture adjustment (PA) and adaptive contrast enhancement (ACE) on the image outputted by image processor 150. After processing the stored image, display processor 154 may cause display 118 to display the processed image. Display 118 may be any type of display. For instance, display 118 may be a panel. Examples of a panel include, but are not limited to, a liquid crystal display (LCD), an organic light emitting diode display (OLED), a cathode ray tube (CRT) display, a plasma display, or another type of display device. Display 118 may include a plurality of pixels that display 218 illuminates to display the viewable content of the processed image as processed by display processor 154.

Frame rate controller 152 may be configured to adaptively control the rate at which frames are output to display 118. The term “frame rate” may be related to the rate at which a display is updated to display distinct images, frames or pictures and in some cases may be described with reference to a display rate or display refresh rate. The frame rate may relate to the rate at which a display buffer is updated. Frame rate controller 152 may adaptively adjust the rate at which frames are output to display 118 by any combination of the following: adjusting the rate at which display buffer is updated, adjusting the rate at which frames are output to display processor 154, adjusting the rate at which a frame compositor or surface flinger generates frames, adjusting the rate at which portions of frames are output by any one of a graphics processing unit, video processing core, or two-dimensional processing core, and/or adjusting the rate at which a graphics software stack, video software or two-dimensional software generates frame data. Frame rate controller 152 may adjust the frame rate by determining the amount of perceivable change between adjacent frames in a frame sequence. In one example, if the perceivable difference between two adjacent frames in a frame sequence is below a threshold the frame rate may be reduced. Further, if the perceivable difference between two adjacent frames in a frame sequence is above a threshold the frame rate may be increased.

As described above, in one example, computing device 102 may be used for image processing in accordance with the systems and methods described herein. Some or all of this functionality may be performed in display interface 116. For example, one or more processors, such as image processor 150, display processor 154, or other processor may be configured to compare a current frame to at least one previous frame to determine an amount of difference. One of the processors may compare a current frame to at least one previous frame to determine an amount of difference and compare the amount of difference between the current frame and the at least one previous frame to a threshold value. The processor may also adjust a frame rate based on the comparison of the amount of difference between the current frame and the at least one previous frame and the threshold value.

In some examples, frame rate controller 152 may implement some or all of the functionality described herein. Frame rate controller 152 may be stand-alone hardware designed to implement the systems and methods described herein. Alternatively, frame rate controller 152 may be hardware that is part of, for example, a chip implementing some aspects of computing device 102.

Frame rate controller 152 may compare a current frame to at least one previous frame to determine an amount of difference and compare the amount of difference between the current frame and the at least one previous frame to a threshold value. The processor may also adjust a frame rate based on the comparison of the amount of difference between the current frame and the at least one previous frame and the threshold value.

In some examples, adjusting the frame rate may include decreasing the frame rate. Decreasing the frame rate may include decreasing the frame rate to a predetermined minimum value. In some examples, adjusting the frame rate may include increasing the frame rate. Increasing the frame rate may include increasing the frame rate to a predetermined maximum value. In this way, the frame rate may be adjusted up or down based on the amount of change between one frame and another frame.

In some examples, one or more processors such as CPU 106, GPU 112, or some combination of processors may compare a current frame to at least one previous frame to determine an amount of difference. Some examples may use one or more dedicated hardware units (not shown) to perform one or more aspects of the systems and methods described herein. Some examples may compare the amount of difference between the current frame and the at least one previous frame to a threshold value. The frame rate may then be adjusted based on the comparison of the amount of difference between the current frame and the at least one previous frame and the threshold value. In an example, adjusting the frame rate may include adjusting the rate at which a display processor, e.g., in display interface 116, outputs frames to display 118. In another example, adjusting the frame rate includes adjusting the rate at which portions of frames are output by any one of a graphics processing unit, e.g., GPU 112; video processing core, e.g., part of display interface 116; or two-dimensional processing core, e.g., part of display interface 116. In another example, adjusting the rate at which portions of frames are output by any one of a graphics processing unit, video processing core, or two-dimensional processing core includes adjusting software application image processing. In an example, adjusting a frame rate based on the determined amount of perceivable difference between the current frame and the at least one previous frame includes reducing the frame rate if the amount of perceivable difference is below a first threshold. In another example, adjusting a frame rate based on the determined amount of perceivable difference between the current frame and the at least one previous frame includes increasing the frame rate if the amount of perceivable difference is above a second threshold. Some examples may be configured to perform combinations of these.

In some examples, the threshold may be predetermined. In other examples, the threshold may be adjustable. In examples where the threshold is predetermined it may also be fixed. In some examples, the threshold may be set based on a determination of perceivability, for example, based on measured differences. The predetermined threshold may be selected based on changes being perceivable to the human eye. Determining changes that may be perceivable to the human eye may vary from person to person. Accordingly, perceptibility may be based on what an average person is capable of perceiving or what some percentage of a population may be able to perceive, which may be determined by testing human visual perceptibility.

In other examples, a predetermined threshold may be selected to decrease power consumption. In such an example, the threshold may be set to require a relatively large amount of change to increase the frame rate and only a relatively low amount of change to decrease frame rate. This may be done, for example, when an amount of batter power in a battery-powered device is relatively low. Perceptibility may also be considered in such an example. For example, the threshold may be set to require the changes between frames that are perceivable to a large percentage of the population to increase the frame rate and only a relatively low amount of change to decrease frame rate.

Some examples may increase the frame rate comprises increasing the frame rate to a predetermined maximum value, e.g., 60 frames-per-minute (FPM). In some example systems, frame rates may be capped to a maximum rate (e.g., 60 frames per second (FPS)). Frame rates may be capped based on application (e.g., live wallpapers may be capped to 20 frames per second).

In some examples, the current frame and the at least one previous frame are generated by one or more of a graphics processing unit, video processing core, two-dimensional graphics core, or frame compositor. One example may determine an amount of perceivable difference between a current frame and at least one previous frame and adjusting a frame rate based on the determined amount of perceivable difference between the current frame and the at least one previous frame.

In one example, a series of frames may be compared. For example, several frames may have to be similar for a decrease in frame rate to occur, while a large enough change in a single pair of frames may cause an increase in frame rate. In some cases such changes may cause an increase to a predetermined maximum frame rate.

One example compares a series of current frames to a series of previous frames to determine difference amounts between frames in the series of current frames and frames in the series of previous frames. Each of the difference amounts may be compared to a threshold. A frame rate may be adjusted based on the comparison of each of the difference amounts and the threshold value. For example, the frame rate may be adjusted down after a predetermined number of comparisons to the threshold that indicate the frame rate may be decreased and the frame rate is adjusted up after a single comparison that to the threshold that indicate the frame rate may be increased. Adjusting the frame rate may also include increasing the frame rate and decreasing the frame rate based on the result of the comparison with the threshold and the threshold includes a first threshold used for decreasing the frame rate and a second threshold is used for increasing the frame rate.

In some examples, frame rates may be increase and decreased between two states, e.g., 20 FPM and 60 FPM. In other examples, frame rate may be increased and decreased by predetermined amounts. In such an example, a maximum frame rate, e.g., 60 FPM, may be used. The increases amount and the decrease amount may not be symmetric. For example, decreases may occur in smaller steps than increases, e.g., any increase may go directly from a current frame rate to a maximum frame rate, e.g., 60 FPM.

The systems and methods described here may require a test to compare a current frame to one or more previous frames. Any test to compare one video frame or picture to another video frame or picture may be used in conjunction with the systems and methods described herein. In one example, comparing a current frame to at least one previous to determine an amount of difference may include performing a structural similarity test.

A structural similarity test may include determining a structural similarity Index. The structural similarity index is a method for measuring the similarity between two images. The structural similarity index may be a full reference metric. The measuring of image quality based on an initial uncompressed or distortion-free image as reference. structural similarity index is designed to improve on traditional methods like peak signal-to-noise ratio (PSNR) and mean squared error (MSE), which, in some cases, maybe inconsistent with human eye perception. It will be understood, however, that some examples may use peak signal-to-noise ratio, mean squared error, or some combination of these.

The difference with respect to other techniques mentioned previously such as MSE or PSNR is that these approaches estimate perceived errors; on the other hand, structural similarity index considers image degradation as perceived change in structural information. Structural information is the idea that the pixels have strong inter-dependencies especially when they are spatially close. These dependencies carry important information about the structure of the objects in the visual scene. In an example, the structural similarity index metric may be calculated on various windows of an image.

Comparing a current frame to at least one previous frame to determine an amount of difference comprises performing a root-mean-squared subtraction of the at least one previous frame and the current frame. The value determined by the threshold may then be compared to a threshold. In another example, comparing a current frame to at least one previous frame to determine an amount of difference may include reducing the resolution of the at least one previous frame and the current frame and comparing the lower resolution version of the at least one previous frame and lower resolution version of the current frame. Some examples may use one or more of these comparison method, or other known comparison methods.

As discussed above, in some examples, the threshold may be modified. For example, the threshold may be modifying to favor more efficient power consumption. Such a modification to the threshold is used to favor more efficient power consumption when a device implementing the method is operating at a high operating temperature relative to the maximum operational temperature of the device. In some examples, the threshold if user adjustable. For example, a user may adjust a frame rate adjusting mechanism or other user input. In some examples, the user may adjust the frame rate directly, however, generally, the user may adjust the threshold rather than directly adjusting frame rate.

In an example according to the instant application, an adaptive frame rate algorithm may be used to change the frame rate. For example, using an adaptive frame rate algorithm that detects how perceptible the changes are between successive frames, the frame rate can be adjusted such that when the changes between frames are not perceptible the frame rate is reduced and when the changes are perceptible the frame rate is increased (up to the limits of the display).

In some examples, by capping the frame rate to the level at which consecutive frames have perceptible changes, the generation of unnecessary frames may be reduced. This reduction in frame generation, may result in the elimination of the computations required to generate the unnecessary frames that may be performed, for example, by CPU 106 and GPU 112. The reduction in frame generation, may also result in fewer writes of data to a display. Accordingly, in some examples, the systems and methods described herein may reduce power, decrease bus usage, or both with possibly a minimal perceptible change in what is displayed.

Some examples may not require any manual tuning or a priori knowledge of applications run on a device implementing these methods. Rather, a comparison between, for example, a pair of frames may be used. These methods may not require pre-analysis of applications.

In some other example systems, frame rates are statically capped to a maximum rate (e.g., 60 frames per second). Frame rates may be capped based on application (e.g., live wallpapers may be capped to 20 frames per second). Applications may be analyzed for FPS requirements and FPS capped per application (side-effect is that CPU 106 usage is reduced). Some of these may requires database mapping application to FPS cap, may not take into account concurrencies, and do not work per surface. In some examples applications are analyzed for FPS requirements and CPU 106 usage is capped per application (side effect is that FPS is reduced). Such examples may require pre-analysis of applications and database mapping application to CPU cap. These examples do not eliminate all processing for frames that are thrown away due to missing deadlines.

In other examples, these may not be required. For example, frames may be compared directly such that analysis of applications, database mapping application, may not be required. Such examples may not require pre-analysis of applications and database mapping application to CPU cap. Additionally, processing of all frames may not be required.

In an example, a frame may be captured. The frame could be an individual layer, surface, or a portion of a final frame. The frame may be compared to a previously captured frame. The change is between the two frames may be rated to determine how perceptible the change is, for example, to the human eye, e.g., from 0—no perceptible change to 100—everything has changed. It will be understood that other values may be used with more granularity, less granularity, different values for no perceptible change and everything has changed, e.g., the opposite of the first example, 100—no perceptible change to 0—everything has changed.

In the example with 0—no perceptible change to 100—everything has changed a threshold between 0 and 100 may be selected. (Generally, 0 and numbers near 0 and 100 and numbers near 100 might be used as the threshold because these are so close to the extremes of the range. This may not always be the case, however.) In such an example, if the change is below a low threshold a processor may reduce the frame rate. If the change is above a high threshold a processor may increase the frame rate.

Some examples may be extended to portions of a frame or layers used to compose a frame. Some examples may be used to controllably degrade user experience when taking steps to mitigate power consumption, thermal issues, or both, e.g., a processor may increase the threshold at which the frame rate is lowered in order to further reduce power or mitigate thermal issues, e.g., to decrease the production of heat by a device that is overheating. In some examples, these issues may override perceptibility. For example, frame rate may be decreased to mitigate power consumption, thermal issues, or both despite some perceived differences between frames.

Some examples may track frame changes across multiple updates. For example, assume a first, second, third, and fourth frames are compared. Some examples may compare the first frame to the second frame, the second frame to the third frame, the third frame to the fourth frame, etc. Other examples may vary the comparison based on the result of other comparisons. For example, some examples may compare whatever frame is currently being displayed. Assume the first frame is being displayed. The first frame may be compared to the second frame. If the compare leads to a slow down such that, for example, the second frame is displayed, but the third frame, then the fourth frame may be compared to the second frame rather than the third frame.

Some examples may work across multiple displays. Such an example may process each display separately and compare frames from each display to other frames for that particular display.

Generally, examples will perform computations to detect how perceptible the changes are between two frames. Accordingly, there may be a tradeoff between use of resources, e.g., power, processor cycles, memory, etc. for the computation versus savings of resources by slowing the frame rate. In some examples, the amount of resources needed for computations to detect the changes should generally be less than the savings in resources resulting from reducing the frame rate so that the net result will actually achieve a savings in resources.

In some examples, hardware may more efficiently implement some aspects of the systems and methods described herein. It will be understood, however, that various aspects might be implemented in software. In some examples, a number of parallel processors may be used to perform the computations. Some examples of these systems and methods may potentially add to memory bandwidth requirements and may cause some visible artifacts. Alternate solutions might also cause visual artifacts, however.

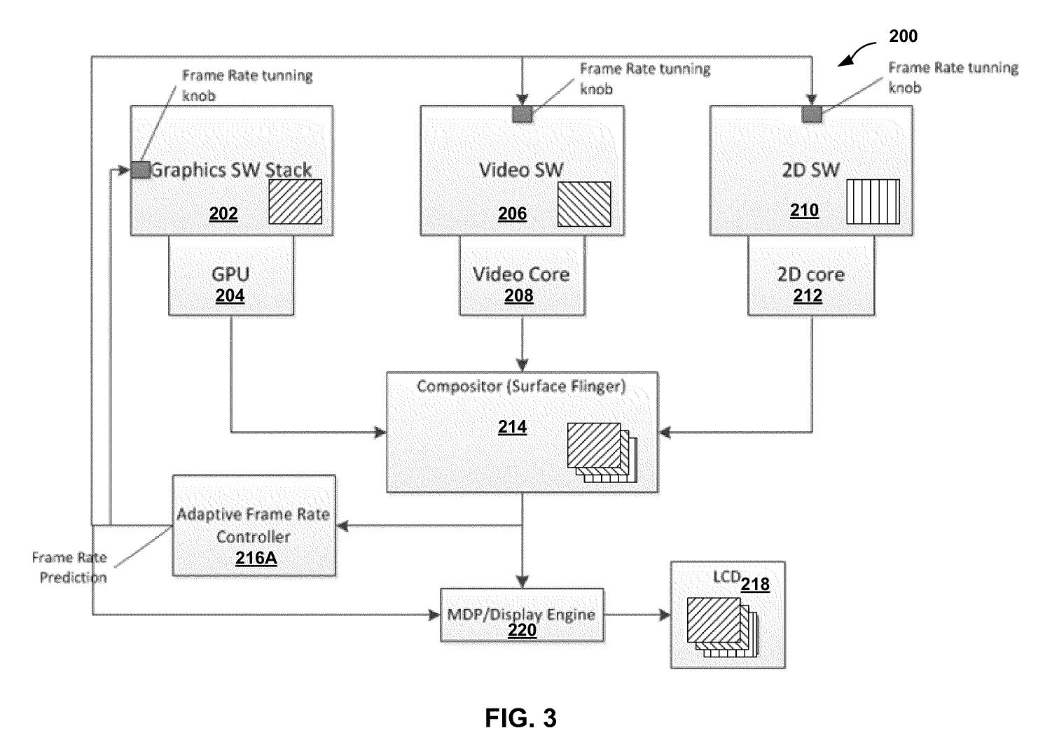

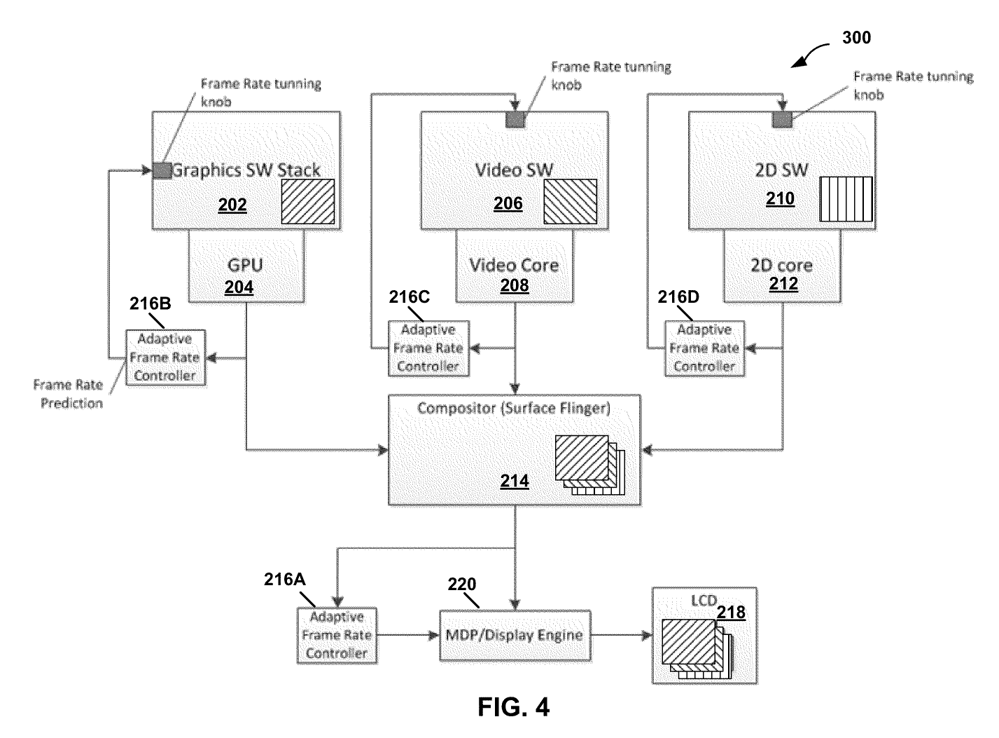

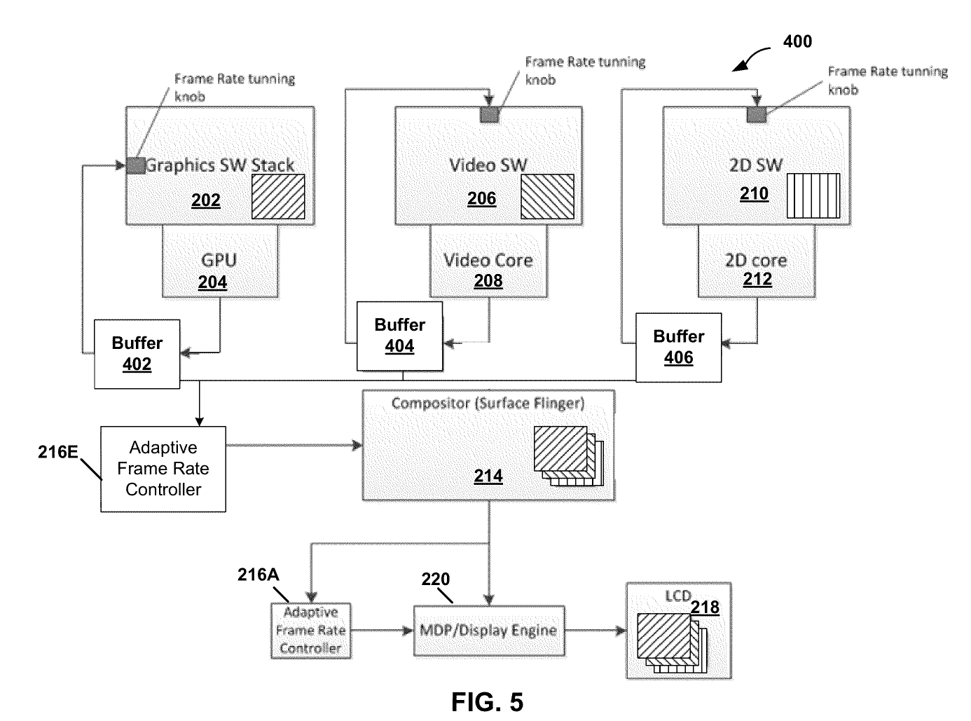

FIGS. 3, 4, and 5 are block diagrams illustrating examples of possible a frame rate controllers that may form the frame rate controller of FIG. 2 in greater detail. As illustrated, in FIGS. 3, 4, and 5 frame rate controllers 200, 300, and 400 include mobile display processor (MDP)/display processor 220 and display 118, such as a liquid crystal display (LCD). Mobile display processor (MDP)/display processor 220 is one example of display processor 220 described in accordance with FIG. 2. The liquid crystal display is one example of a display 218 described in accordance with FIG. 2. As illustrated, in FIGS. 3, 4, and 5 frame rate controllers 200, 300, and 400 also include graphic software stack 202, GPU 204, video software (SW) 206, video core 208, two-dimensional (2D) software (SW) 210, 2D core 212 and frame compositor/surface flinger 214.

Graphic software stack 202 and GPU 204 may be combination of software and hardware configured to generate portions of a frame based on graphics data. Video software (SW) 206 and video core 208 may be combination of software and hardware configured to generate portions of a frame based on video data. Video software (SW) 206 and video core 208 may include a video codec configured to generate a video frame by decoding a video data coding according to a video standard or format such as, for example, MPEG-2, MPEG-4, ITU-T H.264, the emerging High Efficiency Video Coding (HEVC) standard, the VP8 open video compression format, or any other standardized, public or proprietary video compression format. Two-dimensional (2D) software (SW) 210 and 2D core 212 may be a combination of hardware and software configured to generate portions of a frame based on two-dimensional data. Frame compositor 214 may be a combination of hardware and software. Additionally, frame compositor 214 may be configured to combine a portion of a frame generated by graphic software stack 202 and GPU 204, video software (SW) 206 and video core 208, and two-dimensional (2D) software (SW) 210 and 2D core 212 to produce a frame to be output to MDP/display processor 154. MDP/display processor 220 may output frames for display by display 118, e.g., LCD.

Frame rate controller 200, frame rate controller 300, and frame rate controller 400 include adaptive frame controller 216A. Frame rate controller 300 also includes adaptive frame controllers 216B, 216C, and 216D. Frame rate controller 400 also includes adaptive frame rate controller 216E, which, in the illustrated example, is connected through buffers 402, 404, and 406.

Adaptive frame rate controllers 216 may adaptively control the rate at which portions frames are generated by any of graphic software stack 202 and GPU 204, video software (SW) 206 and video core 208, and two-dimensional (2D) software (SW) 210 and 2D core 212. In some examples, adaptive frame rate controllers 216 may adjust the frame rate by comparing a current frame to at least one previous frame to determine an amount of difference, comparing the amount of difference between the current frame and the at least one previous frame to a threshold value, and adjusting a frame rate based on the comparison of the amount of difference between the current frame and the at least one previous frame and the threshold value. In other examples, adaptive frame controllers 216 may adjust the frame rate by determining the amount of perceivable change between adjacent frames in a frame sequence. In one example, if the perceivable difference between two adjacent frames in a frame sequence is below a threshold the adaptive frame controller 216 may reduce the frame rate. Further, if the perceivable difference between two adjacent frames in a frame sequence is above a threshold adaptive frame controller 216 may increase the frame rate. Adaptive frame controller 216 may adjust the frame rate by adjusting a frame rate adjustment mechanism such as a frame rate tuning “knob” of any of graphic software stack 202, video software (SW) 206, and two-dimensional (2D) software (SW) 210. A frame rate-tuning knob may represent a logical function and may be implemented using any combination of hardware and software.

As discussed above, frame rate controller 300 includes additional adaptive frame controllers 216B, 216C, and 216D. Adaptive frame controllers 216B, 216C, and 216D operate in a manner similar to that discussed above with respect to the adaptive frame controllers 216, but are configured to adjust the frame rate by analyzing portions of a frame output by any of respective graphic software stack 202 and GPU 204, video software (SW) 206 and video core 208, and two-dimensional (2D) software (SW) 210 and 2D core 212 and adjusting the rate at which portions of frames are generated by any of graphic software stack 202 and GPU 204, video software (SW) 206 and video core 208, and two-dimensional (2D) software (SW) 210 and 2D core 212. Again, in some examples, adaptive frame rate controllers 216, (e.g., 216B, 216C, and 216D) may adjust the frame rate by comparing a current frame to at least one previous frame to determine an amount of difference, comparing the amount of difference between the current frame and the at least one previous frame to a threshold value, and adjusting a frame rate based on the comparison of the amount of difference between the current frame and the at least one previous frame and the threshold value. In other examples, adaptive frame controllers 216 (e.g., 216B, 216C, and 216D) may adjust the frame rate by determining the amount of perceivable change between adjacent frames in a frame sequence.

As discussed above, frame rate controller 400 includes additional adaptive frame controller 216E. Adaptive frame controller 216E operate in a manner similar to the adaptive frame controllers 216 discussed above, but is configured to adjust the frame rate by analyzing portions of a frame output by any of respective graphic software stack 202 and GPU 204, video software (SW) 206 and video core 208, and two-dimensional (2D) software (SW) 210 and 2D core 212 as connected through buffers 402, 404, and 406. Buffers 402, 404, and 406 allow a single adaptive frame rate controller 216 to adjust the frame rate by analyzing portions of a frame output by any of respective graphic software stack 202 and GPU 204, video software (SW) 206 and video core 208, and two-dimensional (2D) software (SW) 210 and 2D core 212.

Adaptive frame rate controller 216E may adjust the rate at which portions of frames are generated by any of graphic software stack 202 and GPU 204, video software (SW) 206 and video core 208, and two-dimensional (2D) software (SW) 210 and 2D core 212. Again, in some examples, adaptive frame rate controller 216, (e.g., 216E) may adjust the frame rate by comparing a current frame to at least one previous frame to determine an amount of difference, comparing the amount of difference between the current frame and the at least one previous frame to a threshold value, and adjusting a frame rate based on the comparison of the amount of difference between the current frame and the at least one previous frame and the threshold value. In other examples, Adaptive frame controller 216 (e.g., 216E) may adjust the frame rate by determining the amount of perceivable change between adjacent frames in a frame sequence.

Adjusting the rate at which portions of frames are output by any one of a graphics processing unit, video processing core, or two-dimensional processing core includes adjusting software application image processing. In an example, adjusting a frame rate based on the determined amount of perceivable difference between the current frame and the at least one previous frame includes reducing the frame rate if the amount of perceivable difference is below a first threshold. In another example, adjusting a frame rate based on the determined amount of perceivable difference between the current frame and the at least one previous frame includes increasing the frame rate if the amount of perceivable difference is above a second threshold. Some examples may be configured to perform combinations of these.

In some examples, the threshold may be predetermined. In other examples, the threshold may be adjustable. In examples where the threshold is predetermined it may also be fixed. In some examples, the threshold may be set based on a determination of perceivability. For example, the predetermined threshold may be selected based on changes being perceivable to the human eye. Determining changes that may be perceivable to the human eye may vary from person to person. Accordingly, perceptibility may be based on what an average person is capable to perceive or what some percentage of a population may be able to perceive, which may be determined by testing human visual perceptibility.

In other examples, a predetermined threshold may be selected to decrease power consumption. In such an example, the threshold may be set to require a relatively large amount of change to increase the frame rate and only a relatively low amount of change to decrease frame rate. This may be done, for example, when an amount of batter power in a battery-powered device is relatively low. Perceptibility may also be considered in such an example. For example, the threshold may be set to require a changes between frames that are perceivable to a large percentage of the population to increase the frame rate and only a relatively low amount of change to decrease frame rate.

Some examples may increase the frame rate comprises increasing the frame rate to a predetermined maximum value, e.g., 60 frames-per-minute (FPM). In some example systems, frame rates may be capped to a maximum rate (e.g., 60 frames per second). Frame rates may be capped based on application (e.g., live wallpapers may be capped to 20 frames per second).

In some examples, the current frame and the at least one previous frame are generated by one or more of a graphics processing unit, video processing core, two-dimensional graphics core, or frame compositor. One example may determine an amount of perceivable difference between a current frame and at least one and adjust a frame rate based on the determined amount of perceivable difference between the current frame and the at least one previous frame.

In one example, a series of frames may be compared. For example, several frames may have to be similar for a decrease in frame rate to occur, while a large enough change in a single pair of frames may cause an increase in frame rate. In some cases such changes may cause an increase to a predetermined maximum frame rate.

One example compares a series of current frames to a series of previous frames to determine difference amounts between frames in the series of current frames and frames in the series of previous frames. Each of the difference amounts may be compared to a threshold. A frame rate may be adjusted based on the comparison of each of the difference amounts and the threshold value. For example, the frame rate may be adjusted down after a predetermined number of comparisons to the threshold that indicate the frame rate may be decreased and the frame rate is adjusted up after a single comparison that to the threshold that indicate the frame rate may be increased. Adjusting the frame rate may also include increasing the frame rate and decreasing the frame rate based on the result of the comparison with the threshold and the threshold comprises a first threshold used for decreasing the frame rate and a second threshold is used for increasing the frame rate.

In some examples, frame rates may be increase and decreased between two states, e.g., 20 FPM and 60 FPM. In other examples, frame rate may be increased and decreased by predetermined amounts. In such an example, a maximum frame rate, e.g., 60 FPM, may be used. The increases amount and the decrease amount may not be symmetric. For example, decreases may occur in smaller steps than increases, e.g., any increase may go directly from a current frame rate to a maximum frame rate, e.g., 60 FPM.

Any test to compare one video frame or picture to another video frame or picture may be used in conjunction with the systems and methods described herein. In one example, comparing a current frame to at least one previous frame to determine an amount of difference may include performing a structural similarity test.

A structural similarity test may include determining a structural similarity Index. The structural similarity index is a method for measuring the similarity between two images. The structural similarity index may be a full reference metric. The measuring of image quality based on an initial uncompressed or distortion-free image as reference. structural similarity index is designed to improve on traditional methods like peak signal-to-noise ratio and mean squared error, which, in some cases, maybe inconsistent with human eye perception. It will be understood, however, that some examples may use peak signal-to-noise ratio, mean squared error, or some combination of these.

The difference with respect to other techniques mentioned previously such as MSE or PSNR is that these approaches estimate perceived errors; on the other hand, structural similarity index considers image degradation as perceived change in structural information. Structural information is the idea that the pixels have strong inter-dependencies especially when they are spatially close. These dependencies carry important information about the structure of the objects in the visual scene. In an example, the structural similarity index metric may be calculated on various windows of an image.

Comparing a current frame to at least one previous frame to determine an amount of difference comprises performing a root-mean-squared subtraction of the at least one previous frame and the current frame. The value determined and then be compared to a threshold. In another example, comparing a current frame to at least one previous frame to determine an amount of difference may include reducing the resolution of the at least one previous frame and the current frame and comparing the lower resolution version of the at least one previous frame and lower resolution version of the current frame. Some examples may use one or more of these comparison methods, or other known comparison methods.

As discussed above, in some examples, the threshold may be modified. For example, the threshold may be modified to favor more efficient power consumption. Such a modification to the threshold may be used to favor more efficient power consumption when a device implementing the method is operating at a high operating temperature relative to the maximum operational temperature of the device. In some examples, the threshold if user adjustable. For example, a user may adjust a frame rate adjustment mechanism or other user input. In some examples, the user may adjust the frame rate directly, however, generally, the user may adjust the threshold rather than directly adjusting frame rate.

Generally, frames output to a display may be generated in a manner that is not correlated to changes that are noticeable. Accordingly, multiple frames may be generated even though there is no perceptible change between the frames. The generation of the unnecessary frames may result in one or more of extra power consumption, use of extra processor cycles on a CPU, use of extra processor cycles on a GPU 112, 204, and extra bus usage. For example, some displays may use more power when display values are written to the display. Accordingly, unnecessarily writing display values to the display may increase power consumption unnecessarily.

In an example according to the instant application, an adaptive frame rate algorithm may be used to change the frame rate. For example, using an adaptive frame rate algorithm that detects how perceptible the changes are between successive frames, the frame rate can be adjusted such that when the changes between frames are not perceptible the frame rate is reduced and when the changes are perceptible the frame rate is increased (up to the limits of the display).

In some examples, by capping the frame rate to the level at which consecutive frames have perceptible changes, the generation of unnecessary frames may be reduced. This reduction in frame generation, may result in the elimination of the computations required to generate the unnecessary frames that may be performed, for example, by CPU 106 and GPU 112. The reduction in frame generation, may also result in fewer writes of data to a display. Accordingly, in some examples, the systems and methods described herein may reduce power, decrease bus usage, or both with possibly a minimal perceptible change in what is displayed.

Some examples may not require any manual tuning or a priori knowledge of applications run on a device implementing these methods. Rather, a comparison between, for example, a pair of frames may be used. These methods may not require pre-analysis of applications.

In some other example systems, frame rates are statically capped to a maximum rate (e.g., 60 frames per second). Frame rates may be capped based on application (e.g., live wallpapers may be capped to 20 frames per second). Applications may be analyzed for FPS requirements and FPS capped per application (side-effect is that CPU 106 usage is reduced). Some of these may requires database mapping application to FPS cap, may not take into account concurrencies, and do not work per surface. In some examples applications are analyzed for FPS requirements and CPU 106 usage is capped per application (side effect is that FPS is reduced). Such examples may require pre-analysis of applications and database mapping application to CPU cap. These examples do not eliminate all processing for frames that are thrown away due to missing deadlines.

In other examples, these may not be required. For example, frames may be compared directly such that analysis of applications, database mapping application, may not be required. Such examples may not require pre-analysis of applications and database mapping application to CPU cap. Additionally, processing of all frames may not be required.

In an example, a frame may be captured. The frame could be an individual layer, surface, or a portion of a final frame. The frame may be compared to a previously captured frame. The change is between the two frames may be rated to determine how perceptible the change is, for example, to the human eye, e.g., from 0—no perceptible change to 100—everything has changed. It will be understood that other values may be used with more granularity, less granularity, different values for no perceptible change and everything has changed, e.g., the opposite of the first example, 100—no perceptible change to 0—everything has changed.

In the example with 0—no perceptible change to 100—everything has changed a threshold between 0 and 100 may be selected. (Generally, 0 and numbers near 0 and 100 and numbers near 100 might be used as the threshold because these are so close to the extremes of the range. This may not always be the case, however.) In such an example, if the change is below a low threshold a processor may reduce the frame rate. If the change is above a high threshold a processor may increase the frame rate.

Some examples may be extended to portions of a frame or layers used to compose a frame. Some examples may be used to controllably degrade user experience when taking steps to mitigate power consumption, thermal issues, or both, e.g., a processor may increase the threshold at which the frame rate is lowered in order to further reduce power or mitigate thermal issues, e.g., to decrease the production of heat by a device that is overheating. In some examples, these issues may override perceptibility. For example, frame rate may be decreased to mitigate power consumption, thermal issues, or both despite some perceived differences between frames.

Some examples may track frame changes across multiple updates. For example, assume a first, second, third, and fourth frames are compared. Some examples may compare the first frame to the second frame, the second frame to the third frame, the third frame to the fourth frame, etc. Other examples may vary the comparison based on the result of other comparisons. For example, some examples may compare whatever frame is currently being displayed. Assume the first frame is being displayed. The first frame may be compared to the second frame. If the compare leads to a slow down such that, for example, the second frame is displayed, but the third frame, then the fourth frame may be compared to the second frame rather than the third frame.

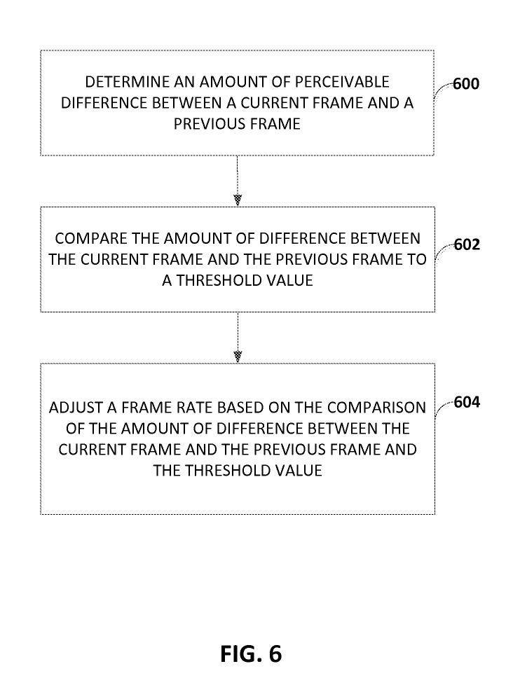

FIG. 6 is a flowchart illustrating an example method in accordance with one or more examples described in this disclosure. In some examples, one or more processor or some combination of processors may implement a method for image processing. The one or more processors may compare a current frame to at least one previous frame to determine an amount of difference (600). As discussed above, any test to compare one video frame or picture to another video frame or picture may be used in conjunction with the systems and methods described herein. In one example, comparing a current frame to at least one previous frame to determine an amount of difference may include performing a structural similarity test.

A structural similarity test may include determining a structural similarity Index. The structural similarity index is a method for measuring the similarity between two images. The structural similarity index may be a full reference metric. The measuring of image quality based on an initial uncompressed or distortion-free image as reference. structural similarity index is designed to improve on traditional methods like peak signal-to-noise ratio and mean squared error, which, in some cases, maybe inconsistent with human eye perception. It will be understood, however, that some examples may use peak signal-to-noise ratio, mean squared error, or some combination of these.

The difference with respect to other techniques mentioned previously such as MSE or PSNR is that these approaches estimate perceived errors; on the other hand, structural similarity index considers image degradation as perceived change in structural information. Structural information is the idea that the pixels have strong inter-dependencies especially when they are spatially close. These dependencies carry important information about the structure of the objects in the visual scene. In an example, the structural similarity index metric may be calculated on various windows of an image.

Comparing a current frame to at least one previous frame to determine an amount of difference comprises performing a root-mean-squared subtraction of the at least one previous frame and the current frame. The value determined by the threshold may then be compared to a threshold. In another example, comparing a current frame to at least one previous frame to determine an amount of difference may include reducing the resolution of the at least one previous frame and the current frame and comparing the lower resolution version of the at least one previous frame and lower resolution version of the current frame. Some examples may use one or more of these comparison method, or other known comparison methods.

The one or more processors or some combination of processors may compare the amount of difference between the current frame and the at least one previous frame to a threshold value (602). In some examples, one or more processors such as CPU 106, GPU 112, or some combination of processors may compare a current frame to at least one previous frame to determine an amount of difference. Some examples may compare the amount of difference between the current frame and the at least one previous frame to a threshold value.

The one or more processors or some combination of processors may adjust a frame rate based on the comparison of the amount of difference between the current frame and the at least one previous frame and the threshold value (604). The frame rate may then be adjusted based on the comparison of the amount of difference between the current frame and the at least one previous frame and the threshold value. In an example, adjusting the frame rate may include adjusting the rate at which a display processor, e.g., in display interface 116, outputs frames to display 118. In another example, adjusting the frame rate includes adjusting the rate at which portions of frames are output by any one of a graphics processing unit, e.g., GPU 112; video processing core, e.g., part of display interface 116; or two-dimensional processing core, e.g., part of display interface 116. In another example, adjusting the rate at which portions of frames are output by any one of a graphics processing unit, video processing core, or two-dimensional processing core includes adjusting software application image processing.

In some examples, adjusting the frame rate may include decreasing the frame rate. Decreasing the frame rate may include decreasing the frame rate to a predetermined minimum value. In some examples, adjusting the frame rate may include increasing the frame rate. Increasing the frame rate may include increasing the frame rate to a predetermined maximum value. In this way, the frame rate may be adjusted up or down based on the amount of change between one frame and another frame.

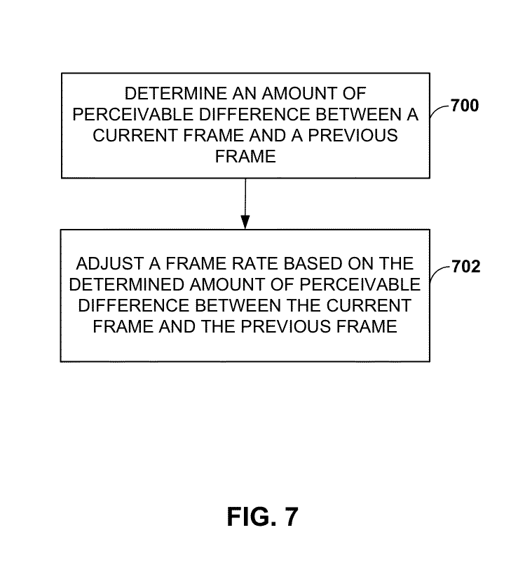

FIG. 7 is a flowchart illustrating an example method in accordance with one or more examples described in this disclosure. In some examples, one or more processor or some combination of processors may implement a method for image processing. The one or more processors may determine an amount of perceivable difference between a current frame and at least one (700). Determining perceivable difference may be based on testing groups of people. It may be based on what an average, e.g., what 50% of a population of test subjects may perceive. It will be understood, however, that many other percentages are possible, e.g., 5%, 10%, 15%, 20%, 25%, 30%, 35%, 40%, 45%, 50%, 55%, 60%, 65%, 70%, 75%, 80%, 85%, 90%, 95%, 100%, or any other percentage. For examples, groups of people may be asked to view video frames and compare them to each other to determine if they can perceive any difference between the video frames. Some of the frames may be the same. Some frames may have varying differences and the amount of difference may be varied from frame to frame. In this way, perceivability of differences between frames may be characterized such that systems and methods described herein may estimate an amount of perceivable difference between a current frame and at least one.

The one or more processors or some combination of processors may adjust a frame rate based on the determined amount of perceivable difference between the current frame and the at least one previous frame (702). As discussed above, in an example, adjusting the frame rate may include adjusting the rate at which a display processor, e.g., in display interface 116, outputs frames to display 118. In another example, adjusting the frame rate includes adjusting the rate at which portions of frames are output by any one of a graphics processing unit, e.g., GPU 112; video processing core, e.g., part of display interface 116; or two-dimensional processing core, e.g., part of display interface 116. In another example, adjusting the rate at which portions of frames are output by any one of a graphics processing unit, video processing core, or two-dimensional processing core includes adjusting software application image processing.

In some examples, adjusting the frame rate may include decreasing the frame rate. Decreasing the frame rate may include decreasing the frame rate to a predetermined minimum value. In some examples, adjusting the frame rate may include increasing the frame rate. Increasing the frame rate may include increasing the frame rate to a predetermined maximum value. In this way, the frame rate may be adjusted up or down based on the amount of change between one frame and another frame.

Some examples of the systems and methods described herein may work across multiple displays. For example, such an example may process each display separately and compare frames from each display to other frames for that particular display.

Generally, examples will perform computations to detect how perceptible the changes are between two frames. Accordingly, there may be a tradeoff between use of resources, e.g., power, processor cycles, memory, etc. for the computation versus savings of resources by slowing the frame rate. Accordingly, in some examples, the amount of resources needed for computations to detect the changes should generally be less than the savings in resources resulting from reducing the frame rate so that the net result will actually achieve a savings in resources.

In some examples, hardware may more efficiently to implement some aspects of the systems and methods described herein. It will be understood, however, that various aspects might be implemented in software. In some examples, a number of parallel processors may be used to perform the computations. Some examples of these systems and methods may potentially add to memory bandwidth requirements and may cause some visible artifacts. Alternate solutions might also cause visual artifacts, however.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method for image processing, the method comprising:
comparing a current frame to at least one previous frame to determine an amount of difference;
comparing the amount of difference between the current frame and the at least one previous frame to a threshold value; and
adjusting a frame rate based on the comparison of the amount of difference between the current frame and the at least one previous frame and the threshold value.

2. The method of claim 1, wherein adjusting the frame rate includes decreasing the frame rate.

3. The method of claim 2, wherein decreasing the frame rate comprises decreasing the frame rate to a predetermined minimum value.

4. The method of claim 1, wherein adjusting the frame rate includes increasing the frame rate.

5. The method of claim 4, wherein increasing the frame rate comprises increasing the frame rate to a predetermined maximum value.

6. The method of claim 1, wherein the threshold is predetermined.

7. The method of claim 1, wherein the threshold is adjustable.

8. The method of claim 7, further comprising modifying the threshold to favor more efficient power consumption.

9. The method of claim 7, further comprising modifying the threshold to favor more efficient power consumption when a device implementing the method is operating at a high operating temperature relative to a maximum operational temperature of the device.

10. The method of claim 1, wherein the threshold if user adjustable.

11. The method of claim 1, wherein the current frame and the at least one previous frame are generated by one or more of a graphics processing unit, video processing core, two-dimensional graphics core, or frame compositor.

12. The method of claim 1, wherein adjusting the frame rate includes adjusting the rate at which a display processor outputs frames to a display.

13. The method of claim 1, wherein adjusting the frame rate includes adjusting the rate at which portions of frames are output by any one of a graphics processing unit, video processing core, or two-dimensional processing core.

14. The method of claim 13, wherein the graphics processing unit, video processing core, or two-dimensional processing core are adjustable independently.

15. The method of claim 13, wherein the graphics processing unit, video processing core, or two-dimensional processing core are adjustable in unison.

16. The method of claim 13, wherein adjusting the rate at which portions of frames are output by any one of a graphics processing unit, video processing core, or two-dimensional processing core includes adjusting software application image processing.

17. The method of claim 1, wherein the threshold is set based on a determination of perceivability of a difference between the current frame and the at least one previous frame.

18. The method of claim 17, wherein adjusting a frame rate based on the determination of perceivability of a difference between the current frame and the at least one previous frame includes reducing the frame rate if the amount of perceivable difference is below a first threshold.

19. The method of claim 17, wherein adjusting a frame rate based on the determination of perceivability of a difference between the current frame and the at least one previous frame includes increasing the frame rate if the amount of perceivable difference is above a second threshold.

20. The method of claim 1, further comprising
comparing a series of current frames to a series of previous frames to determine difference amounts between frames in the series of current frames and frames in the series of previous frames;
comparing each of the difference amounts to a threshold; and
adjusting a frame rate based on the comparison of each of the difference amounts and the threshold value.

21. The method of claim 20, wherein the frame rate is adjusted down after a predetermined number of comparisons to the threshold that indicate the frame rate may be decreased and the frame rate is adjusted up after a single comparison that to the threshold that indicate the frame rate may be increased.

22. The method of claim 1, wherein adjusting the frame rate comprises increasing the frame rate and decreasing the frame rate based on a result of the comparison with the threshold and the threshold comprises a first threshold used for decreasing the frame rate and a second threshold is used for increasing the frame rate.

23. The method of claim 1, wherein comparing the current frame to the at least one of the previous frames to determine an amount of difference comprises performing a structural similarity test.

24. The method of claim 1, wherein comparing the current frame to the at least one of the previous frames to determine an amount of difference comprises performing a root-mean-squared subtraction of the at least one previous frame and the current frame.

25. The method of claim 1, wherein comparing the current frame to the at least one previous frame to determine an amount of difference comprises reducing a resolution of the at least one previous frame to create a lower resolution version of the at least previous frame and reducing a resolution of the current frame to create a lower resolution version of the current frame and comparing the lower resolution version of the at least one previous frame and the lower resolution version of the current frame.

26. A device for image processing comprising:
a processor configured to:
compare a current frame to at least one previous frame to determine an amount of difference;
compare the amount of difference between the current frame and the at least one previous frame to a threshold value; and
adjust a frame rate based on the comparison of the amount of difference between the current frame and the at least one previous frame and the threshold value.

27. The device of claim 26, wherein adjusting the frame rate includes decreasing the frame rate.

28. The device of claim 27, wherein decreasing the frame rate comprises decreasing the frame rate to a predetermined minimum value.

29. The device of claim 26, wherein adjusting the frame rate includes increasing the frame rate.

30. The device of claim 29, wherein increasing the frame rate comprises increasing the frame rate to a predetermined maximum value.

31. The device of claim 26, wherein the threshold is predetermined.

32. The device of claim 26, wherein the threshold is adjustable.

33. The device of claim 32, wherein the processor is further configured to modify the threshold to favor more efficient power consumption.

34. The device of claim 32, wherein the processor is further configured to modify the threshold to favor more efficient power consumption when a device implementing the method is operating at a high operating temperature relative to a maximum operational temperature of the device.

35. The device of claim 26, wherein the threshold if user adjustable.

36. The device of claim 26, wherein the processor is further configured to generate the current frame and the at least one previous frame by directing one or more of a graphics processing unit, video processing core, two-dimensional graphics core, or frame compositor.

37. The device of claim 26, wherein adjusting the frame rate includes adjusting the rate at which a display processor outputs frames to a display.

38. The device of claim 26, wherein adjusting the frame rate includes adjusting the rate at which portions of frames are output by any one of a graphics processing unit, video processing core, or two-dimensional processing core.

39. The device of claim 38, wherein the graphics processing unit, video processing core, or two-dimensional processing core are adjustable independently.

40. The device of claim 38, wherein the graphics processing unit, video processing core, or two-dimensional processing core are adjustable in unison.

41. The device of claim 38, wherein adjusting the rate at which portions of frames are output by any one of a graphics processing unit, video processing core, or two-dimensional processing core includes adjusting software application image processing.

42. The device of claim 26, wherein the threshold is set based on a determination of perceivability, wherein the perceivability is based on the determined difference.

43. The device of claim 42, wherein adjusting a frame rate based on the determination of perceivability of a difference between the current frame and the at least one previous frame includes reducing the frame rate if the amount of perceivable difference is below a first threshold.

44. The device of claim 43, wherein adjusting a frame rate based on the determination of perceivability of a difference between the current frame and the at least one previous frame includes increasing the frame rate if the amount of perceivable difference is above a second threshold.

45. The device of claim 26, further comprising:
comparing a series of current frames to a series of previous frames to determine difference amounts between frames in the series of current frames and frames in the series of previous frames;
comparing each of the difference amounts to a threshold; and
adjusting a frame rate based on the comparison of each of the difference amounts and the threshold value.

46. The device of claim 45, wherein the frame rate is adjusted down after a predetermined number of comparisons to the threshold that indicate the frame rate may be decreased and the frame rate is adjusted up after a single comparison that to the threshold that indicate the frame rate may be increased.

47. The device of claim 26, wherein adjusting the frame rate comprises increasing the frame rate and decreasing the frame rate based on a result of the comparison with the threshold and the threshold comprises a first threshold used for decreasing the frame rate and a second threshold is used for increasing the frame rate.

48. The device of claim 26, wherein comparing a current frame to the at least one previous frame to determine an amount of difference comprises performing a structural similarity test.

49. The device of claim 26, wherein comparing a current frame to the at least one previous frame to determine an amount of difference comprises performing a root-mean-squared subtraction of the at least one previous frame and the current frame.

50. The device of claim 26, wherein comparing the current frame to the at least one previous frame to determine an amount of difference comprises reducing a resolution of the at least one previous frame to create a lower resolution version of the at least previous frame and reducing a resolution of the current frame to create a lower resolution version of the current frame and comparing the lower resolution version of the at least one previous frame and the lower resolution version of the current frame.

51. A device for image processing comprising:
means for comparing a current frame to at least one previous frame to determine an amount of difference;
means for comparing the amount of difference between the current frame and the at least one previous frame to a threshold value; and
means for adjusting a frame rate based on the comparison of the amount of difference between the current frame and the at least one previous frame and the threshold value.

52. The device of claim 51, wherein adjusting the frame rate includes decreasing the frame rate.

53. The device of claim 52, wherein decreasing the frame rate comprises decreasing the frame rate to a predetermined minimum value.

54. The device of claim 51, wherein adjusting the frame rate includes increasing the frame rate.

55. The device of claim 54, wherein increasing the frame rate comprises increasing the frame rate to a predetermined maximum value.

56. The device of claim 51, wherein the threshold is adjustable.

57. The device of claim 51, further comprising:
comparing a series of current frames to a series of previous frames to determine difference amounts between frames in the series of current frames and frames in the series of previous frames;
comparing each of the difference amounts to a threshold; and
adjusting a frame rate based on the comparison of each of the difference amounts and the threshold value.

58. The device of claim 57, wherein the frame rate is adjusted down after a predetermined number of comparisons to the threshold that indicate the frame rate may be decreased and the frame rate is adjusted up after a single comparison that to the threshold that indicate the frame rate may be increased.

59. The device of claim 51, wherein comparing a current frame to the at least one previous frame to determine an amount of difference comprises performing a structural similarity test.

60. The device of claim 51, wherein comparing the current frame to the at least one previous frame to determine an amount of difference comprises reducing a resolution of the at least one previous frame to create a lower resolution version of the at least previous frame and reducing a resolution of the current frame to create a lower resolution version of the current frame and comparing the lower resolution version of the at least one previous frame and the lower resolution version of the current frame.

61. The device of claim 51, wherein comparing the current frame to the at least one previous frame to determine an amount of difference comprises reducing a resolution of the at least one previous frame to create a lower resolution version of the at least previous frame and reducing a resolution of the current frame to create a lower resolution version of the current frame and comparing the lower resolution version of the at least one previous frame and the lower resolution version of the current frame.

62. A non-transitory computer readable storage medium storing instructions that upon execution by one or more processors cause the one or more processors to:
compare a current frame to at least one previous frame to determine an amount of difference;
compare the amount of difference between the current frame and the at least one previous frame to a threshold value; and
adjust a frame rate based on the comparison of the amount of difference between the current frame and the at least one previous frame and the threshold value.

63. The non-transitory computer readable storage medium of claim 62, wherein the instructions, upon execution by the one or more processors, cause the one or more processors to adjust the frame rate, which includes decreasing the frame rate.

64. The non-transitory computer readable storage medium of claim 62, wherein the instructions, upon execution by the one or more processors, cause the one or more processors to adjust the frame rate, which includes increasing the frame rate.

65. A method for image processing, the method comprising:
determining an amount of perceivable difference between a current frame and at least one previous frame; and
adjusting a frame rate based on the determined amount of perceivable difference between the current frame and the at least one previous frame.
